(19) United States
(12) Patent Application Publication
(10) Pub. No.: US 2026/0219719 A1
(43) Pub. Date: Jul. 30, 2026

(54) METHOD FOR OPERATING A POWER DEVICE, CONTROLLER FOR A POWER DEVICE, AND POWER ASSEMBLY INCLUDING A POWER DEVICE AND SUCH A CONTROLLER

(71) Applicant: Rolls-Royce Solutions GmbH, Friedrichshafen (DE)

(72) Inventor: Karsten Harder, Oberteuringen (DE)

(73) Assignee: Rolls-Royce Solutions GmbH, Friedrichshafen (DE)

(21) Appl. No.: 19/468,643

(22) Filed: Feb. 3, 2026

Related U.S. Application Data
(63) Continuation of application No. PCT/DE2024/100675, filed on Jul. 30, 2024.

(30) Foreign Application Priority Data
Aug. 3, 2023 (DE) 10 2023 120 690.7

(51) Int. Cl. G06F 1/28; G05B 15/02

(52) U.S. Cl. CPC G06F 1/28; G05B 15/02

(57) ABSTRACT

A method for operating a power device by way of a controller includes: determining—based on (i) a nominal model formed from inventory data, which includes a first mapping between at least one input variable and at least one output variable, and (ii) a detail model generated during operation of the controller by use of a plurality of measured values, which includes a second mapping between the at least one input variable and the at least one output variable—at least one deviation variable which relates to a deviation of an operating behavior of at least one component of the power device from a standard operating behavior; determining a deviation function as a temporal development of at the least one deviation variable; and using the deviation function as a basis to predict a future development of the at least one component.

### CROSS REFERENCE TO RELATED APPLICATIONS

This is a continuation of PCT application no. PCT/DE2024/100675, entitled “METHOD FOR OPERATING A POWER DEVICE, CONTROLLER FOR A POWER DEVICE, AND POWER ASSEMBLY COMPRISING A POWER DEVICE AND SUCH A CONTROLLER”, filed Jul. 30, 2024, which is incorporated herein by reference. PCT application no. PCT/DE2024/100675 claims priority to German patent application no. 10 2023 120 690.7, dated Aug. 3, 2023, which is incorporated herein by reference.

### BACKGROUND OF THE INVENTION

### 1. Field of the Invention

The present invention relates to power devices.

### 2. Description of the Related Art

Deviations in the operation of a power device such as actuator and/or sensor faults are typically detected via local trends or limit value monitoring. Unfortunately, however, only large deviations from the ideal state can be reliably detected. A more targeted option arises if the power device is controlled using a model-based approach. However, in the case of physical models this requires a significant development effort, whereby suitable models must be identified and a suitable reconciliation with measurement data must be performed. Also, there is an increasing requirement to no longer perform maintenance or replacement of components according to rigid time schedules, but only on an as-needed basis, oriented towards actual or predicted wear, defects, or failure probabilities. The trend statements or forecasts necessary for this cannot be made easily or with sufficient precision on the basis of local trends or limit value monitoring, wherein, again, with regard to physical models the aforementioned disadvantages apply.

What is needed in the art is a method for operating a power device, a controller for a power device and a power arrangement with a power device and such a controller, wherein the aforementioned disadvantages are at least reduced, optionally do not occur.

### SUMMARY OF THE INVENTION

The invention relates to a method for operating a power device, a controller for a power device and a power assembly comprising a power device and such a controller.

The present invention provides a method for operating a power device, wherein, on the basis of a nominal model formed from inventory data which includes a first mapping between at least one input variable and at least one output variable, and a detail model generated during operation of the controller by use of measured values, which includes a second mapping between the at least one input variable and the at least one output variable, at least one deviation variable is determined which relates to a deviation of an operating behavior of at least one component of the power device from a standard operating behavior, whereby a deviation function is determined as temporal development of at the least one deviation variable, and wherein the deviation function is used as a basis to predict a future development of at least one component. Thus, a prediction for the operation of at least one component can be advantageously developed in a resource-saving and at the same time reliable way, which also enables need-based maintenance or a need-based replacement of at least one component. Advantageously, this method makes it possible to provide a resource-efficient and reliable prediction for the operation of the at least one component, also enabling need-based maintenance or replacement of the at least one component. This takes advantage of the fact that with the nominal model on the one hand and the detail model on the other, different mappings between the at least one input variable and the at least one output variable are available, which can be used to determine the deviation variable. Since the nominal model is based on inventory data, it remains unchanged during the operation of the power device, whereas the detail model is expanded during operation, based on measured values. Thus, the detail model always contains current information regarding the actual operating behavior of the power device, wherein—if the power device functions as intended, especially if the actuators and sensors function correctly—it is systematically expanded, adapted, and thereby improved. However, if a deviation occurs during the operation of the power device, for example an actuator and/or sensor error, the creation and especially the expansion of the detail model based on measured values leads to a systematic divergence from the nominal model, resulting in a systematic deviation between the models during ongoing operation. In the context of the herein proposed method, this is advantageously exploited, not only to determine a deviation but also to project it into the future and thus generate a prediction.

In one embodiment, the standard operating behavior is defined by the nominal model. The deviation variable thus specifically refers to a deviation between the operating behavior described by the detail model and the operating behavior of at least one component described by the nominal model.

In one embodiment, the deviation variable is determined by comparing the detail model with the nominal model. In one arrangement, the deviation variable is determined by comparing the second mapping with the first mapping.

In one embodiment, the deviation variable is determined repeatedly, particularly periodically; in particular, the comparison of the detail model with the nominal model is performed repeatedly, optionally periodically. Alternatively, or additionally, the deviation variable is determined in an event-driven manner; in particular, the comparison of the detail model with the nominal model is performed in an event-driven manner. “Event-driven” means that determination of deviation variation is initiated or triggered by a triggering event or signal. Such triggering events could, for example be, when a predetermined operating time threshold or operational performance threshold of the power device or of the at least one component is reached, the occurrence of a predetermined detected malfunction, or the like.

In the context of the present technical teaching, an output variable is generally understood to be any variable that can be determined, and in particular calculated, by a controller of the power device, in particular by way of an open loop or closed loop method, for example, by way of a model-based predictive method. Accordingly, an input variable is generally understood to be any variable that can be used to determine, in particular calculate, an output variable. The input variable can be supplied externally or can alternatively also be calculated. In one embodiment, the input variable may itself be another output variable determined by the controller or obtained from another controller. It is possible that an output variable is determined, in particular calculated, depending on a plurality of input variables. Alternatively, or additionally, a plurality of output variables can be determined, in particular calculated, from the at least one input variable.

In one embodiment of the method, a value of at least one input variable used to control the power device is determined by way of a model-based predictive method. In one arrangement, the value of the input variable used to control the power device is calculated based on the detail model. In addition, the detail model, and also the nominal model is used as an observer structure, which is also used to monitor the operation of the power device and in particular to detect deviations.

Alternatively, the value of at least one input variable used to control the power device is determined by way of another open loop or closed loop method, in particular a map-based method. In this design, the detail model and the nominal model are used as an observer structure that is not used directly to control the power device, but—in this case in particular exclusively—to monitor its operation and especially to detect deviations. In one embodiment, the at least one input variable is also calculated using the detail model for the purpose of detecting deviations, either in parallel with or in addition to determining the value used for control by way of the other open loop or closed loop method.

In the context of the present technical teaching, a model-based predictive method is understood in particular as a model predictive control (MPC).

In the context of the present technical teaching, a nominal model is generally understood to be a model that is formed on the basis of inventory data, and is in particular parameterized, whereby the nominal model is static or fixed during the runtime of the controller, in other words, it is not changed or adjusted during the runtime of the controller.

In the context of the present technical teaching, a detail model is generally understood to be an allocation of at least one output variable to the at least one input variable, which is created by way of measured values. In a simple design the detail model may include a collection, table, or database of values recorded during operation of the power device for the at least one input variable and the at least one output variable. In another embodiment, the detail model is a model that may also be used for the open loop or closed loop method, and according to one design is in fact used. In one embodiment, the detail model is based on the nominal model, wherein the detail model is modified from the nominal model during the runtime of the controller in particular expanded by measured values obtained from the power device and thus adapted to the operation of the specific power device-optionally in the field of application.

In the context of the present technical teaching, inventory data is generally understood to be data taken from an existing database, optionally obtained before commissioning of a specific controller or power device. In one design, the inventory data is not collected in real time, in particular not during the operating time of the specific controller or power device. The inventory data can be measured, for example, on a test bench or obtained from models or simulations, especially highly accurate ones, or in the past, from the field of application of other controllers or power devices.

In one embodiment, the nominal model is parameterized in such a way that it minimizes a mean square error of at the least one output variable by varying the at least one input variable and at the same time can extrapolate reliably and meaningfully outside the measuring space included in the parameterization. In another embodiment, the detail model is parameterized analogously, wherein it is optionally arranged to minimize the same error depending on the at least one input variable; however, the detail model is expanded during operation-especially at points of high information content-so that the model accuracy increases.

In one arrangement, the output variable is also determined, and in particular calculated, based on the detail model, optionally based on the model-based predictive method, especially by way of model predictive control.

A further development of the present invention provides that a future deviation in the operating behavior of the at least one component will be determined using the deviation function. A reliable forecast of operating behavior of the at least one component can be obtained advantageously in this way. In one embodiment, the future deviation in operating behavior of the at least one component is determined by using the deviation function for at least one prediction time. It is possible that the future deviation is determined for a plurality of predicted times. This provides a particularly detailed prediction of future operating behavior.

In one embodiment, future aging of the at least one component is determined by the deviation function. Alternatively, or additionally, future wear of at least the one component is determined by way of the deviation function. This approach advantageously provides reliable planning of need-based maintenance and/or replacement of at the least one component.

A further development of the invention provides that that a predicted end of operational life for the at least one component is determined by way of the deviation function by considering a tolerance range predetermined for at least one component. In one arrangement, the predicted end of operational life is defined as the time at which, according to the prediction determined by the deviation function, the predetermined tolerance range is first exceeded or a limit of the predetermined tolerance range is reached. Advantageously, the determination of a predicted end of operational life allows for reliable planning of a need-based replacement of the at least one component and thus avoids, in particular, premature replacement that would not be cost efficient, as well as unnecessary downtimes of the power device.

A further development of the invention provides that the deviation function will be extrapolated over time. This represents a simple and reliable method for updating the deviation value in the future.

A further development of the invention provides that as the at least one input variable a control specification is used for the control of at least one control element as the at least one component of the power device. The control specification can be a direct control variable for a control element, in other words, a variable that is used directly to control the control element. Alternatively, the control specification can be a variable depending on which a further control specification, for example a direct control variable for a control element, is determined, or in particular calculated. In one embodiment, the control specification is a fuel mass, depending on which, at least one direct control variable can be determined for the appropriate control of a fuel injector or fuel valve with which the fuel injector or fuel valve is controlled in order to introduce the fuel mass into a combustion chamber or an air path of the power device. In another arrangement, the control specification is a fuel mass to be introduced into a combustion chamber or an air path of an internal combustion engine.

The at least one control element can be a control element or an actuator of the power device. The control element can in particular be a control element of an engine block of an internal combustion engine, for example, an injector, a valve, or a flap. However, the control element can also be a control element outside the power device, for example, outside an engine block, such as a control element designed to influence an externally supplied cooling circuit, like a valve, a pump, or the like, or a control element of a transmission or an electrical device with which the power device is operatively connected.

Alternatively, or additionally it is provided that the at least one output variable is a physical observable detected by at least one sensor as the at least one component of the power device. In the context of the present technical teaching, a physical observable is generally understood to be a measured variable or measurable value, for example a temperature, in particular air or exhaust gas temperature, a mass, in particular air mass or exhaust gas mass, a chemical concentration or partial pressure, a pressure, an electric current or an electrical voltage.

In one embodiment, the output variable is an exhaust gas temperature, specifically an exhaust gas temperature of an internal combustion engine.

In one embodiment, the input variable as a control specification is a fuel mass to be introduced into a combustion chamber or air path of an internal combustion engine, and the output variable is an exhaust gas temperature of the internal combustion engine. Optionally, additional model variables are implemented in the nominal model and the detail model as input variables and/or output variables, for example, nitrogen oxide emissions, power, in particular engine power, peak combustion pressure, boost pressure, air mass, injection start, rail pressure, charge air temperature, and/or high-temperature cooling circuit temperature.

A further development of the invention provides that as the at least one input variable a plurality of input variables is used as input vectors. In another embodiment, the input variables are selected from a group consisting of fuel mass, boost pressure, air mass, injection start, rail pressure, charge air temperature, and high-temperature cooling circuit temperature. In another arrangement, a plurality of control parameters for controlling a respectively assigned control element are used as the control vector of a plurality of components of the power device. In this case, the control vector is the input vector, and the control parameters are the input variables.

Alternatively, or in addition, it is provided that as the at least one output variable a plurality of output variables are used as the output vector. The output variables are selected from a group consisting of exhaust gas temperature, nitrogen oxide emissions, power, in particular engine power, peak combustion pressure, boost pressure, air mass, injection start, rail pressure, charge air temperature, and high-temperature cooling circuit temperature.

Alternatively, or in addition, the at least one deviation variable is determined as a plurality of deviation variables, in particular as a deviation vector. The deviation vector thereby includes the plurality of deviation variables as vector components. Thus, a plurality of deviations can be determined advantageously in a resource-considerate manner.

A further development of the invention provides that as the at least one deviation variable, a variable is determined, selected from a group consisting of an input deviation variable and an output deviation variable. In one arrangement, at least two variables are determined as the at least one deviation variable: at least one input deviation variable and at least one output deviation variable.

In one embodiment, an input deviation variable is understood to be a deviation assigned to a control specification. This can be a deviation in the implementation of the control specification due for example, to a defective, dirty, aged or worn control element wherein the control element is not able to implement the control specification correctly, for example due to a deficit such as a defect, contamination, wear or ageing. Specifically, the input deviation variable is a control element deviation variable.

In one embodiment, an output deviation variable is understood to be a deviation assigned to an observable. This can be in particular a systematic measurement error or a sensor error. For example, it can be a measurement error caused by a sensor deficiency such as a defect, contamination, wear, or aging.

A further development of the invention provides that as the at least one deviation variable, at least one input deviation variable and at least one output deviation variable are determined, wherein as the deviation function a multidimensional temporal development of the at least one input deviation variable and the at least one output deviation variable is determined. In one arrangement, the deviation function serves to predict a future development of a complex component of the at least one component of the power device.

In the context of the present technical teaching, a multidimensional temporal development is generally understood to be a vector-valued deviation function as a function of time. Based on the vector-valued deviation function the future development of the complex component can be predicted.

A complex component is generally understood to be a component that cannot be described by a single control specification and/or a single measured value, wherein the behavior of the complex component is determined by a plurality of parameters. A complex component is, for example, an SCR catalytic converter, whose operating behavior can be characterized, for example, by a maximum conversion rate, wherein the maximum conversion rate is determined by a plurality of measured values and/or control specifications.

A further development of the invention provides that at least one input variable of at least one input variable has assigned to it a detail output variable on the basis of the detail model and a nominal output variable based on the nominal model, wherein the at least one deviation variable is calculated on the basis of at least one detail output variable and the at least one nominal output variable. In one embodiment, a detail output variable and a nominal output variable are assigned to a plurality of input variables, in particular in order to assign a detail output vector and a nominal output vector to an input vector. In particular, a comparison of the detail output variable with the nominal output can advantageously determine a deviation in the behavior of at least one component from the standard operating behavior. In particular, the detail model is compared with the nominal model by comparing the at least one detail output variable with the at least one nominal output variable.

In one embodiment-based on a specific input variable-a correction variable or correction vector is calculated which minimizes a deviation between the detail output variable assigned to the specific input variable according to the detail model and the nominal output variable assigned to the specific input variable according to the nominal model with the correction variable applied. The correction variable is obtained in particular as the deviation variable, or the deviation variable is determined from the correction variable.

A further development of the invention provides that a first Gaussian process model is used as the nominal model.

Gaussian process models are particularly suitable for model-predictive control of a power device: compared to polynomial-based models, they are easier to adapt to new or changed data points in the field of application, and they exhibit a more suitable and physically correct behavior in marginal areas of given parameter space. Compared to physical models, significantly less computational effort is required. In addition, they enable direct use of test bench data, in particular data from highly accurate simulations or models, or even field data from the field of application.

The nominal model as a Gaussian process model is given in particular from stored data points, for example obtained in test bench tests or from simulations or models, wherein with X_{N ε} R^{n×m} in particular n input variables for m different operating conditions are stated and with Y_{Nε} R^{m×k} in particular k output variables for the m different operating conditions are stated. Moreover, the Gaussian process model results from a specified calculation scheme for an expected value E_{ε}R^{l×k} and a variance Var for input variables not contained in the original data set for l different operating states XᵤεR^{n×l}.

$$E ( {X}_{u} ) = m ( {X}_{u} ) + K ( {X}_{u} , {X}_{N} ) {( K ( {X}_{N} , {X}_{N} ) + {σ}^{2} I )}^{- 1} ( {Y}_{N} - m ( {X}_{N} ) ) , \qquad ( 1 )$$

$$Var ( {X}_{u} ) = K ( {X}_{u} , {X}_{u} ) + {σ}^{2} - K ( {X}_{u} , {X}_{N} ) {( K ( {X}_{N} , {X}_{N} ) + {σ}^{2} I )}^{- 1} K ( {X}_{N} , {X}_{u} ) , \qquad ( 2 )$$

with a mean function m, a predetermined variance σ², the unit matrix I, and a covariance function K, which depends on the Euclidean distance r between two points x₁, x₂ as shown:

$$K ( {X}^{1} , {X}^{2} ) = {( k ( {X}_{1 : n , i}^{1} , {X}_{1 : n , j}^{2} ) )}_{i = 1 , … , m , j = 1 , … , m} , \qquad ( 3 )$$

$$k ( {x}_{1} , {x}_{2} ) = {σ}_{F}^{2} exp ( - \frac{r {( {x}_{1} , {x}_{2} )}^{2}}{2 {l}^{2}} ) , \qquad ( 4 )$$

with a predetermined distance parameter/and a predetermined signal variance σ_{F}. Therefore, equations (1) and (2) K(Xᵤ,X_{N})ϵ [symbol] ^{l×m}, K(X_{N},X_{N})ϵ [symbol] ^{m×m}, Iϵ [symbol] ^{m×m} and Y_{N}ϵ [symbol] ^{m×k} apply.

The mean value function m is optionally obtained again as a Gaussian process model.

In order to obtain the nominal model, a first Gaussian process model, also known as a basic grid, is first adapted to a second set of inventory data under at least one secondary condition derived from initial inventory data, which is test bench data, or data obtained from highly accurate models or simulations. In particular, input variables Xx are selected, and the corresponding output variables Y_{N} are calculated such that a deviation of expected value E of the first Gaussian process model, which is determined by input variables Xx and output variables Y_{N}, to the second inventory data is minimized in compliance with the secondary condition. Moreover, for the purpose of determining the first Gaussian process model, m=0 is optionally assumed for its mean function. The first set of inventory data thereby covers a larger parameter space than the second set of inventory data. In particular, it is possible that the first set of inventory data is measured on a single-cylinder test bench, while the second set of inventory data is measured on the full engine or also on the single-cylinder test bench and in the latter case is optionally converted to the full engine by a simulation model. The secondary condition is optionally obtained as a trend where it is for example determined whether certain parameters are linear or monotonic to each other. If no such trend is detected, the secondary condition can be omitted, wherein the adaptation of the first Gaussian process model to the second set of inventory data is then also described as unlimited. Finally, the nominal model is obtained as the adapted first Gaussian process model.

According to a further development of the invention, a second Gaussian process model is used as the detail model. In one design, the second Gaussian process model uses the first Gaussian process model as mean value function. Thus, the detail model has the nominal model as mean value function.

In particular, the expected value obtained from the first Gaussian process model is used as the mean value function m in the detail model, in which the second inventory data are now included as known input variables X_{D2} and output variables Y_{D2}. Thus, input variables X_{D2} and output variables Y_{D2} which are known from the inventory data become subsets of input variables X_{D} and output variables Y_{D} of the detail model, respectively.

In one embodiment, the detail model is adapted according to equations (1) to (4) during operation of the power device, in other words, in the field of application. For this purpose, measured values, that is, newly measured data points, are supplemented in particular during operation of the power device, or data points from the inventory data that are identified as not being suitable for improvement are replaced by newly measured data points.

In one arrangement, the at least one deviation variable, in particular the deviation vector, is determined as follows:

Detail model vectors Y_{D} of the output variables are summarized in all q detail model points with regard to corresponding input vectors X_{D}:

$${Y}_{D , diag} = diag ( [ {Y}_{D} ( {X}_{D , 1} ) , … , {Y}_{D} ( {X}_{D , q} ) ] ) . \qquad ( 5 )$$

Analogously, all associated nominal model vectors Y_{N} of the output variables are summarized in all q detail model points with respect to associated input vectors X_{D}, by considering an input correction vector D_{X}:

$${Y}_{N , diag} ( Δ X ) = diag ( [ {Y}_{N} ( {X}_{D , 1} + Δ X ) , … , {Y}_{N} ( {X}_{D , q} + Δ X ) ] ) . \qquad ( 6 )$$

Alternatively, to the additive offset used in equation (6), a multiplicative deviation can also be assumed by combining input correction vector D X—with a suitable definition—multiplicatively with input variables X_{D}.

From equations (5) and (6) the following optimization problem can now be obtained for input correction vector D X:

$$Δ X = arg {min}_{Δ X} {‖ I - {Y}_{N , diag} ( Δ X ) {Y}_{D , diag}^{- 1} ‖}_{2}^{2} . \qquad ( 7 )$$

In looking for input correction vector D X that minimizes the expression in the standard of equation (7), the desired deviation vector, that is, the deviation variable, is found as input correction vector D X that minimizes the expression in the standard of equation (7). This represents the deviation of the detail model trained by measured values from the nominal model obtained from inventory data and thus any deviations in operating behavior from the standard operating behavior.

The described procedure can be expanded by considering an output correction vector D Y as an alternative or in addition to the consideration of the input correction vector D X in order to find errors in the output variables:

$${Y}_{D , diag} ( Δ Y ) = diag ( [ {Y}_{D} ( {X}_{D , 1} ) + Δ Y , … , {Y}_{D} ( {X}_{D , q} ) + Δ Y ] ) . \qquad ( 8 )$$

For combined consideration of input correction vector D X and output correction vector D Y, the following optimization problem can be solved in particular:

$$[ Δ X , Δ Y ] = arg {min}_{[ Δ X , Δ Y ]} {‖ I - {Y}_{N , diag} ( Δ X ) {Y}_{D , diag}^{- 1} ( Δ Y ) ‖}_{2}^{2} . \qquad ( 9 )$$

Input correction vector D X and output correction vector D Y are optimized in particular separately according to equation (9).

In particular, at least one deviation variable of at least one of the two correction vectors DX, DY is now determined as the at least one deviation variable at a first time k and at least at one additional time k+D k; this is formally explained herein for the combination of both correction vectors [D X, D Y]ₖ, whereby the application to only one correction vector is trivial. A model for the temporal progression of at least one deviation variable is now established, whereby in the simplest case it is assumed that this increases linearly with time, in particular starting from normal operating behavior (A X)=0, D Y=0):

$${[ Δ X , Δ Y ]}_{k + Δ k} = [ {m}_{X} , {m}_{Y} ] \cdot Δ k , \qquad ( 10 )$$

with increases [m_{X}, m_{Y}], which can be determined, for example, by scalar, i.e., element-by-element, recursive least squares estimation (RLS).

For a component such as for example an actuator or a sensor, a tolerance range is assumed whose limit is established by a maximum permissible deviation [D X^{max}, D Y^{max}]. The predicted end of operational life of, for example, an actuator, is then given as a time F_{X} at which the maximum permissible deviation D X^{max} is reached:

$${F}_{X} = \frac{Δ {X}^{max}}{{m}_{X}} . \qquad ( 11 )$$

The predicted end of the operational life of a sensor is given as a time F_{Y} at which the maximum permissible deviation D Y^{max} is reached:

$${F}_{Y} = \frac{Δ {Y}^{max}}{{m}_{Y}} , \qquad ( 12 )$$

More complex predictions for complex components such as an SCR catalytic converter can be made by moving the nominal model.

$${Y}_{N , k} ( X ; k ) = {Y}_{N} ( X + {km}_{X} ) + {km}_{Y} \qquad ( 13 )$$

For example, aging of an SCR catalytic converter moves the point of maximum conversion. The end of the SCR catalytic converter's operational life Fis reached when the maximum conversion drops below a certain minimum. This can be formulated as a multi-criteria optimization problem for the respective model outcome:

$$[ \sim , F ] = arg {min}_{[ X , k ]} [ k , - {Y}_{N , k} ( X ; k ) ] \qquad ( 14 )$$

$$s . t . {Y}_{N , k} ( X ; k ) = {Y}^{min} .$$

The lower limit for maximum conversion serves as model output Y^{min}.

Analogously, depending on the model output and physical conditions, similar optimization problems can be formulated for determining ends of service life or wear points.

The present invention also provides a controller for a power device, which is arranged to perform a method according to the invention or a method according to one or more of the embodiments described above. In connection with the controller, the advantages apply which have already been explained in connection with the method.

The controller is designed in particular to operate the power device. In one embodiment, the controller is designed to operate an internal combustion engine, an internal combustion engine-generator combination device, a fuel cell, an energy storage device, in particular a battery, an electrolyzer, a data center or microgrid, or another controllable or adjustable load on an electrical network. In one embodiment, the controller is designed to determine the at least one input variable for controlling, in particular for regulating, the power device. Specifically, the controller is designed to control the power device with the at least one input variable.

The present invention also provides a power assembly including a power device and a controller according to the invention, or a controller according to one or several of the embodiments described above. In connection with the power assembly, the advantages arise that have already been explained in connection with the method or the controller.

In the context of the present technical teaching, a power device is generally understood to be a device that is arranged to provide power, in particular electrical and/or mechanical power, or to convert or consume power. The power device can thus be designed, in particular, as a power supply device or as a power conversion device. A power supply device is generally understood to be a device that provides power, in particular electrical and/or mechanical power, using electrical, mechanical, chemical, or electrochemical energy, or another form of energy. A power conversion device is generally understood to be a device that uses or consumes power, in particular electrical or mechanical power, in order to convert or store energy, for example, to provide chemical energy in the form of certain substances such as hydrogen or methanol, or electrochemical energy, using electrical energy. In particular, the power device can be an internal combustion engine, an internal combustion engine-generator combination device, in other words, a genset, a fuel cell, an energy storage device, in particular a battery or an electrolyzer. The power device can also be a larger, more complex system, for example, consisting of several of the aforementioned devices, or in particular a data center or a microgrid. Specifically, the power device can also be a controllable or adjustable load on an electrical network.

A further development of the invention provides that the power device is designed as an internal combustion engine, an internal combustion engine-generator combination device, a fuel cell, an energy storage device, in particular a battery, an electrolyzer, a data center or microgrid, or another controllable or adjustable load on an electrical network.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of a power assembly with a design example of a power device and a design example of a controller;

FIG. 2 is a schematic representation of an embodiment of a method for operating the power device; and

FIG. 3 is a schematic representation of the operating principle of the method according to FIG. 2 in the form of a diagram.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

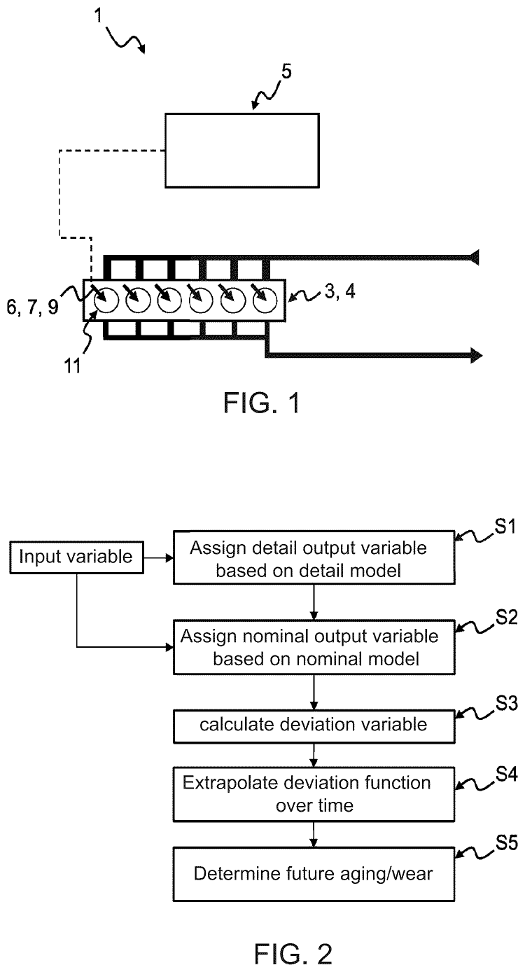

FIG. 1 is a schematic representation of a design example of a power assembly 1 with a design example of a power device 3 and a design example of a controller 5.

In this example, power device 3 is designed as an internal combustion engine 4.

Alternatively, power device 3 can be an internal combustion engine-generator combination device or a fuel cell. However, it can also be designed, in particular, as an energy storage device, especially a battery, electrolyzer, data center or microgrid, or as another controllable or adjustable load on an electrical network.

Controller 5 is operatively connected with power device 3 in order to control power device 3.

Controller 5 is arranged to carry out a method for operating power device 3 as described below.

Using a nominal model formed from inventory data, which includes a first mapping between at least one input variable and at least one output variable, and a detail model created during operation of controller 5 on the basis of measured values, which includes a second mapping between the at least one input variable and the at least one output variable, at least one deviation variable is determined which relates to a deviation of an operating behavior of at least one component 6 of the power device from a standard operating behavior defined by the nominal model. A deviation function is determined as the temporal development of at least one deviation variable and based on the deviation function a future development of at least one component 6 is predicted.

In the design example shown here, the at least one input variable is a control specification for controlling at least one control element 7 of power device 3 as the at least one component 6. Optionally, the control specification is a fuel mass, wherein, depending on the fuel mass, at least one direct control specification is determined for the suitable control of a fuel injector 9 of power device 3, which is designed as an internal combustion engine 4, with which fuel injector 9 is controlled in order to introduce the fuel mass into a combustion chamber 11. For the sake of clarity, respectively only one control element 7, fuel injector 9, and combustion chamber 11 are each identified with their respective reference numerals, whereby internal combustion engine 4 can have a plurality of combustion chambers 11, each with an associated control element 7, namely a fuel injector 9.

Moreover, in the design example shown here, the at least one output variable is a physical observable of the power device, in particular an exhaust gas temperature of internal combustion engine 4.

Additional model variables are implemented optionally in the nominal model and the detail model as input variables and/or output variables, for example boost pressure, air mass, injection start, rail pressure, nitrogen oxide emissions, power, in particular engine power, combustion peak pressure, charge air temperature, and high-temperature cooling circuit temperature.

FIG. 2 is a schematic representation of one embodiment of a method for operating power device 3.

Identical and functionally equivalent elements are provided with the same reference symbols in all drawings, so that reference is made to the preceding description in each case.

In first step S1, at least one input variable has assigned to it a detail output variable based on the detail model. In second step S2, at least one input variable has assigned to it a nominal output variable based on the nominal model. In third step S3, the at least one deviation variable is calculated on the basis of the at least one detail output variable and the at least one nominal output variable, in particular by optimizing an input correction vector and/or an output correction vector, in particular in accordance with equation (7) or equation (9). In fourth step S4, the deviation function is extrapolated over time, and in fifth step S5, future aging or wear of the at least one component 6 is determined on the basis of the time-extrapolated deviation function. Optionally, in fifth step S5, a predicted end of operational life for the at least one component 6 is determined based on the time-extrapolated deviation function, considering a tolerance range that is predetermined for the at least one component 6.

A first Gaussian process model is optionally used as the nominal model. A second Gaussian process model is optionally used as the detail model. In one arrangement, the detail model features the nominal model as a mean value function.

Optionally, a plurality of input variables is used as the input vector for the at least one input variable. Alternatively, or additionally, a plurality of output variables is used as the output vector for the at least one output variable. Alternatively, or additionally, the at least one deviation variable is determined as a plurality of deviation variables, in particular as a deviation vector.

Optionally, an input deviation variable and/or an output deviation variable is determined as the at least one deviation variable.

In an optional embodiment, at least one input deviation variable and at least one output deviation variable are determined as the at least one deviation variable, wherein a multidimensional time evolution of the at least one input deviation variable and the at least one output deviation variable is determined as the deviation function. Based on the deviation function, predictions are optionally made in regard to a future development of a complex component 6, such as an SCR catalytic converter.

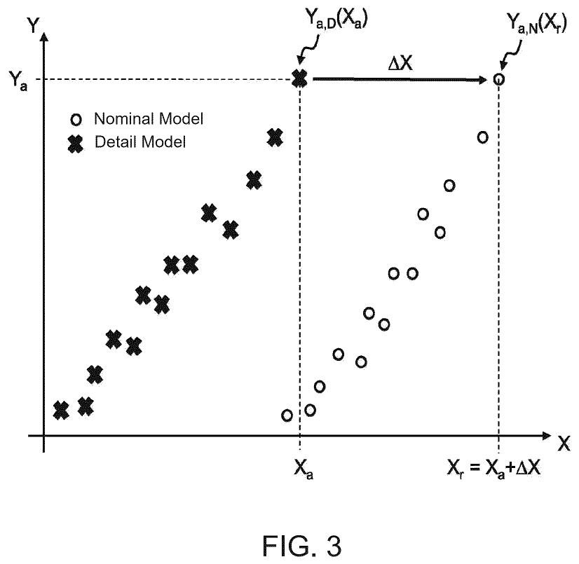

FIG. 3 is a schematic representation of the operating principle of the method according to FIG. 2, in the form of a diagram.

The operating principle of the method based on FIG. 3 is shown in particular by way of a simplified low-dimensional representation.

In this example, an input variable X, for example a fuel mass, is plotted against an output variable Y, which is, for example, an exhaust gas temperature. It is assumed that one of the fuel injectors 9 of combustion engine 4 has a deviation from its normal operating behavior, in particular a leakage, so that when controlled with a certain fuel mass it actually injects a larger fuel mass. The black, solid crosses represent the allocation between input variable X and output variable Y according to the detail model; the blank circles represent the allocation between input variable X and output variable Y according to the nominal model. Due to the deviation in the form of the leakage of fuel injector 9, the detail model differs from the nominal model which shows the standard operating behavior in that the fuel masses used to control fuel injectors 9 are systematically assigned exhaust gas temperatures that are too high, since in real terms more fuel is always injected than corresponds to the fuel mass used as the control specification.

At a specific sampling time, an additive or multiplicative correction vector ΔX is calculated, starting from a given fuel mass Xₐ, such that the deviation between exhaust gas temperature Y_{a,D}(Xₐ) calculated as a detail output variable according to the detail model as a function of the fuel mass Xₐ and the exhaust gas temperature Y_{a,N}(Xᵣ=Xₐ+ΔX)—or in the multiplicative case Y_{a,N}(Xᵣ=Xₐ·ΔX)—calculated from the nominal model as a nominal output variable as a function of fuel mass Xᵣ modified by the correction vector ΔX is minimized. In this way, the optimized correction vector DX provides a deviation variable that allows predictions to be made about the existing deviation from normal operating behavior, in this case the leakage of fuel injector 9.

Alternatively, or in addition to determining an (input) correction vector DX for the input variable, it is possible to analogously determine an output correction vector DY for the output variable, and thus, for example, to detect and optionally correct a sensor error.

The detail model points represent the current situation of power device 3 at the sampling time, whereas the nominal model points represent an average deviation-free case for the same input situation.

In a multidimensional case, artificial intelligence or a neural network can be used to deduce the actual deviation from the obtained multidimensional input correction vector DX and/or output correction vector DY. The deviation can be validated using further input and/or output variables. For example, it can be decided that simultaneous deviations in boost pressure and air mass of internal combustion engine 4 indicate a clogged air filter, or an injector fault can be validated by comparing exhaust gas temperature and nitrogen oxide emissions.

This procedure is then repeated for a plurality of sampling times, resulting in different values for the at least one deviation variable at the different sampling times, and consequently yielding a discrete deviation function as temporal development of the at least one deviation variable. This permits a temporal extrapolation of the deviation function, optionally in the form of a linear regression. A predicted end of service life for the at least one component 6, for example fuel injector 9, can then be easily determined from the increase calculated for the deviation function, by considering a predetermined tolerance range.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a power device by way of a controller, the method comprising the steps of:
determining—based on (i) a nominal model formed from inventory data, which includes a first mapping between at least one input variable and at least one output variable, and (ii) a detail model generated during operation of the controller by use of a plurality of measured values, which includes a second mapping between the at least one input variable and the at least one output variable—at least one deviation variable which relates to a deviation of an operating behavior of at least one component of the power device from a standard operating behavior;
determining a deviation function as a temporal development of at the least one deviation variable; and
using the deviation function as a basis to predict a future development of the at least one component.

2. The method according to claim 1, wherein a future deviation in the operating behavior of the at least one component is determined by way of the deviation function.

3. The Method according to claim 2, wherein the future deviation is a future aging or a future wear of the at least one component.

4. The method according to claim 1, wherein a predicted end of an operational life for the at least one component is determined by way of the deviation function by considering a tolerance range predetermined for the at least one component.

5. The method according to claim 1, wherein the deviation function is extrapolated over time.

6. The method according to claim 1, wherein at least one of:
(a) the at least one input variable is a control specification for control of at least one control element as the at least one component of the power device; and
(b) the at least one output variable is a physical observable detected by at least one sensor as the at least one component of the power device.

7. The method according to claim 1, wherein at least one:
(a) as the at least one input variable a plurality of input variables are used as an input vector;
(b) as the at least one output variable a plurality of output variables are used as an output vector; and
(c) the at least one deviation variable is determined as a plurality of deviation variables.

8. The method according to claim 1, wherein at least one of:
(a) as the at least one input variable a plurality of input variables are used as an input vector, the plurality of input variables being a plurality of control specifications for controlling a respectively assigned control element as a control vector of a plurality of the at least one component of the power device;
(b) as the at least one output variable a plurality of output variables are used as an output vector; and
(c) the at least one deviation variable is determined as a plurality of deviation variables, which is a plurality of deviation vectors.

9. The method according to claim 1, wherein a variable is determined as the at least one deviation variable that is selected from a group consisting of an input deviation variable and an output deviation variable.

10. The method according to claim 1, wherein as the at least one deviation variable at least one input deviation variable and at least one output deviation variable is determined, wherein the deviation function is a multidimensional temporal development of the at least one input deviation variable and the at least one output deviation variable.

11. The method according to claim 10, wherein the deviation function serves to predict the future development of a complex component of the at least one component of the power device.

12. The method according to claim 1, wherein at least one input variable of the at least one input variable is assigned a detail output variable by way of the detail model and a nominal output variable by way of the nominal model, wherein the at least one deviation variable is calculated based on the at least one detail output variable and the at least one nominal output variable.

13. The method according to claim 1, wherein a first Gaussian process model is used as the nominal model.

14. The method according to claim 13, wherein a second Gaussian process model is used as the detail model.

15. The method according to claim 14, wherein a second Gaussian process model is used as the detail model, which uses the first Gaussian process model as a mean value function.

16. A controller for a power device, the controller comprising:
the controller, which is configured for performing a method for operating the power device by way of the controller, the method including the steps of:
determining—based on (i) a nominal model formed from inventory data, which includes a first mapping between at least one input variable and at least one output variable, and (ii) a detail model generated during operation of the controller by use of a plurality of measured values, which includes a second mapping between the at least one input variable and the at least one output variable—at least one deviation variable which relates to a deviation of an operating behavior of at least one component of the power device from a standard operating behavior;
determining a deviation function as a temporal development of at the least one deviation variable; and
using the deviation function as a basis to predict a future development of the at least one component.

17. A power assembly, comprising:
a power device; and
a controller, which is configured for performing a method for operating the power device by way of the controller, the method including the steps of:
determining—based on (i) a nominal model formed from inventory data, which includes a first mapping between at least one input variable and at least one output variable, and (ii) a detail model generated during operation of the controller by use of a plurality of measured values, which includes a second mapping between the at least one input variable and the at least one output variable—at least one deviation variable which relates to a deviation of an operating behavior of at least one component of the power device from a standard operating behavior;
determining a deviation function as a temporal development of at the least one deviation variable; and
using the deviation function as a basis to predict a future development of the at least one component.

18. The power assembly according to claim 17, wherein the power device is an internal combustion engine, an internal combustion engine-generator combination device, a fuel cell, an energy storage device, an electrolyzer, a data center or microgrid, or another controllable or adjustable load on an electrical network.
